(19) United States
(12) Patent Application Publication
(10) Pub. No.: US 2018/0297178 A1
(43) Pub. Date: Oct. 18, 2018

(54) Valve Wheel Wrench

(71) Applicant: Derek Knepp, Port Neches, TX (US)

(72) Inventor: Derek Knepp, Port Neches, TX (US)

(21) Appl. No.: 15/820,346

(22) Filed: Nov. 21, 2017

Related U.S. Application Data
(60) Provisional application No. 62/486,706, filed on Apr. 18, 2017.

(51) Int. Cl. B25B 13/50; B25B 23/16

(52) U.S. Cl. CPC B25B 13/5008; B25B 23/16

(57) ABSTRACT

Methods and systems are provided of providing a valve wheel wrench comprising a jaw assembly at a first end comprising first and second jaws configured to securably engage at least a portion of a valve wheel, wherein the orientation of the first jaw is opposite to the orientation of the second jaw, and a handle at a second end, connected to the first end via a shaft, wherein a portion of the handle is surrounded by a guard configured to shield at least a portion of the hand of a user.

### CROSS-REFERENCE TO RELATED APPLICATION

This application claims benefit to U.S. Provisional Patent Application Ser. No. 62/486,706, filed on Apr. 18, 2017 which is incorporated by reference herein.

### TECHNICAL FIELD

The present disclosure is generally related to valve wrenches and, more particularly, is related to valve wheel wrenches.

### BACKGROUND

Operation of valve wrenches, especially wheel valve wrenches, may pose some level of risk to the user of same including discomfort and bruising. The risk of user injury is further increased when a valve wrench is used in a refinery environment in which a valve wheel is surrounded by hard metallic surfaces in the event the wrench slips off of a valve wheel.

### BRIEF SUMMARY

Example embodiments of the present disclosure provide valve wheel wrenches. Briefly described, in architecture, one example embodiment of the wrench, among others, includes a jaw assembly at a first end comprising first and second jaws configured to securably engage at least a portion of a valve wheel, where the orientation of the first jaw is opposite to the orientation of the second jaw, and a handle at a second end, connected to the first end via a shaft, where a portion of the handle is surrounded by a guard configured to shield at least a portion of the hand of a user. Additional embodiments of a valve wheel wrench include a guard comprised of one or more loop members. Further still, alternate embodiments include a valve wheel wrench with a guard comprising a basket shaped member.

Alternate embodiments of the present disclosure can also be viewed as providing valve wheel wrenches. In this regard, one embodiment of such an apparatus, among others, can be broadly summarized by a jaw assembly at a first end adapted to securably engage at least a portion of a valve wheel to turn it, and a handle member at a second end, connected to the first end via a shaft, where a portion of the handle member, distal to the first end, comprises a guard member surrounding at least a portion of the shaft wherein the guard member is configured to protect one or more hands of a user.

According to still yet another embodiment of the present disclosure, provides a valve wheel wrench including a first end comprising first and second jaws opposably oriented and separated by an opening there between to accept and securably engage at least a portion of the valve wheel, and a handle at second end, connected to the first end via a shaft, wherein the handle comprises a guard member surrounding at least a portion of the shaft and is configured to protect at least a portion of the hand of a user.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a side perspective view of a valve wrench in accordance with the present disclosure.

FIG. 2 is a partial quarter perspective view of a portion of an embodiment of a valve wrench in accordance with the present disclosure.

FIG. 3 is an opposite side perspective view of a valve wrench in accordance with the present disclosure.

FIGS. 4A and 4B show top and side and sectional views of an example embodiment of a valve wrench in accordance with the present disclosure.

FIG. 5 is a partial perspective view of a valve wrench on a valve wheel in accordance with the present disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible.

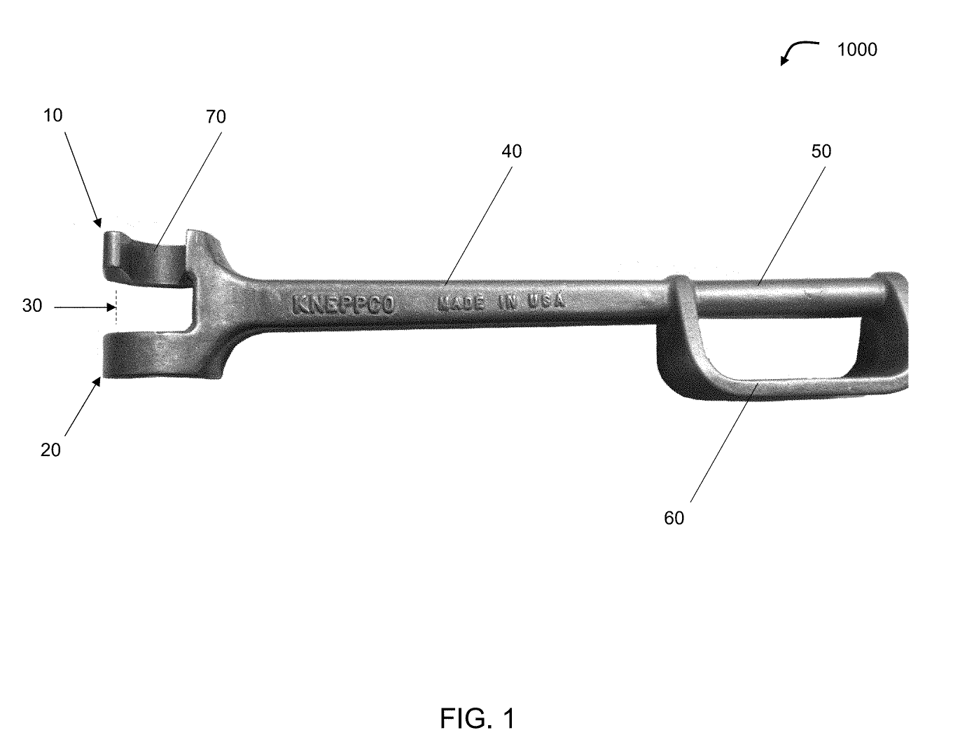

FIG. 1 is a side perspective view of a valve wrench 1000 in accordance with the present disclosure. The valve wrench 1000 includes a first end including a first jaw 10 and a second jaw 20 separated by a gap 30. The gap 30 between first and second jaws 10, 20 is configured to accept and engage at least a portion of a valve wheel for turning. A shaft 40 extends to a handle assembly 50 located at a distal, second end, of the wrench.

A guard 60 surrounds a portion of shaft 40/handle 50 to shield and protect the hand of a user when operating the wrench. According to some embodiments of the present disclosure, guard 60 may be sized in a configuration that protects one or more hands user when operating the wrench. In other embodiments, guard 60 may include a basket, or cup-like feature, while others may include a bar-like handle guard.

As also shown in FIG. 1, the inner portion of first jaw 10 includes a first seat 70. First seat 70 may be contoured to engage a portion of a valve wheel. As shown, first and second jaws 10, 20 are opposably fixed and configured to releasably engage a valve wheel at least a portion or portions of the valve wheel. It will be appreciated that first and second jaws 10. 20 may be collectively referred to as a jaw assembly. It will be appreciated, however, that a jaw assembly may be comprised of one or more jaws.

It will be appreciated that the wrench and portions thereof may be comprised of any suitable materials including but not limited to aluminum, steel, iron, alloys, composites, carbon, and the like. The wrench may be manufactured via any number of methods including but not limited to drop forging, CNC milling, casting, molding, extrusion, 3-D printing, and the like. Embodiments of the present disclosure may vary in size according to use, much in the way that sockets come in different sized metric and SAE units.

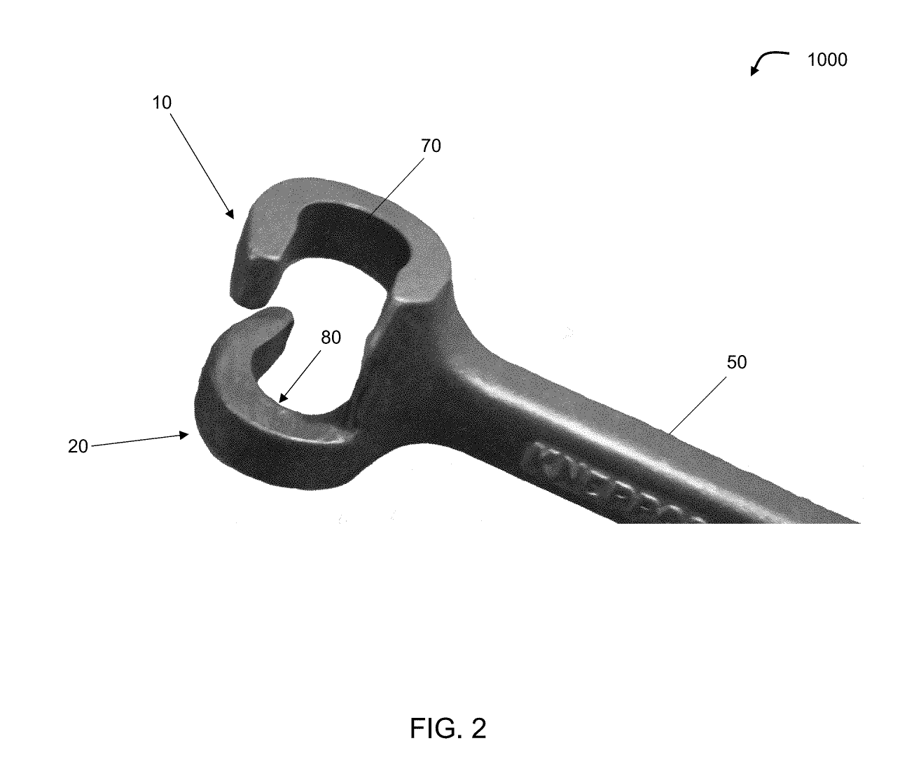

FIG. 2 is a three-quarter perspective view of the upper portion of an embodiment of the valve wrench 1000 of FIG. 1. As shown, first jaw 10 includes a first seat 70 and second jaw 20 includes a second seat 80. According to some embodiments, first and second seats 70, 80 are configured to releasably engage a valve wheel at a first and second location.

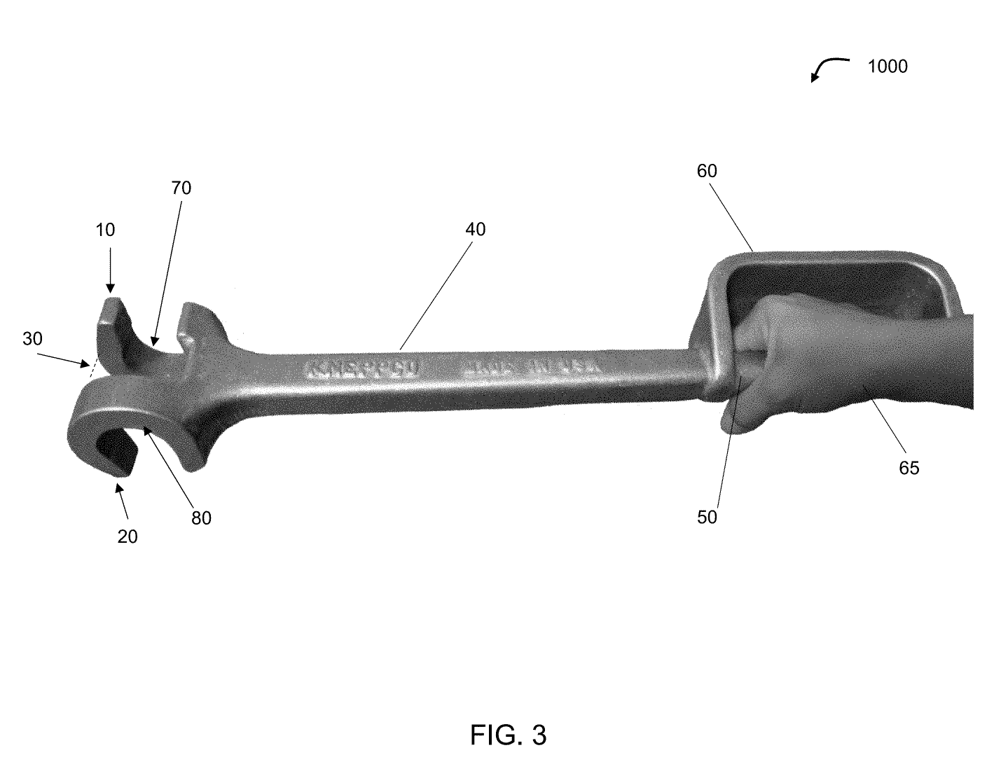

FIG. 3 is a perspective view of a portion of an embodiment of a valve wrench in accordance with the present disclosure. FIG. 3 shows the hand of a user 65 grasping the handle 50 and surrounded by guard member 60. It will be appreciated by one of ordinary skill in the art that while guard member 60 is depicted in a loop shaped configuration that partially surrounds and shields a portion of the hand of a user, other shapes may be used including a basket, a cup, one or more loops, and/or one or more loop members of various thicknesses and coverage. In some embodiments, a wider or slimmer guard may be used to cover the knuckles of the hand of a user. It will be appreciated that according to some embodiments of the present disclosure that handle 50 may be referred to as a handle member or handle assembly and include portions of guard member 60 and associated portions of the shaft 40.

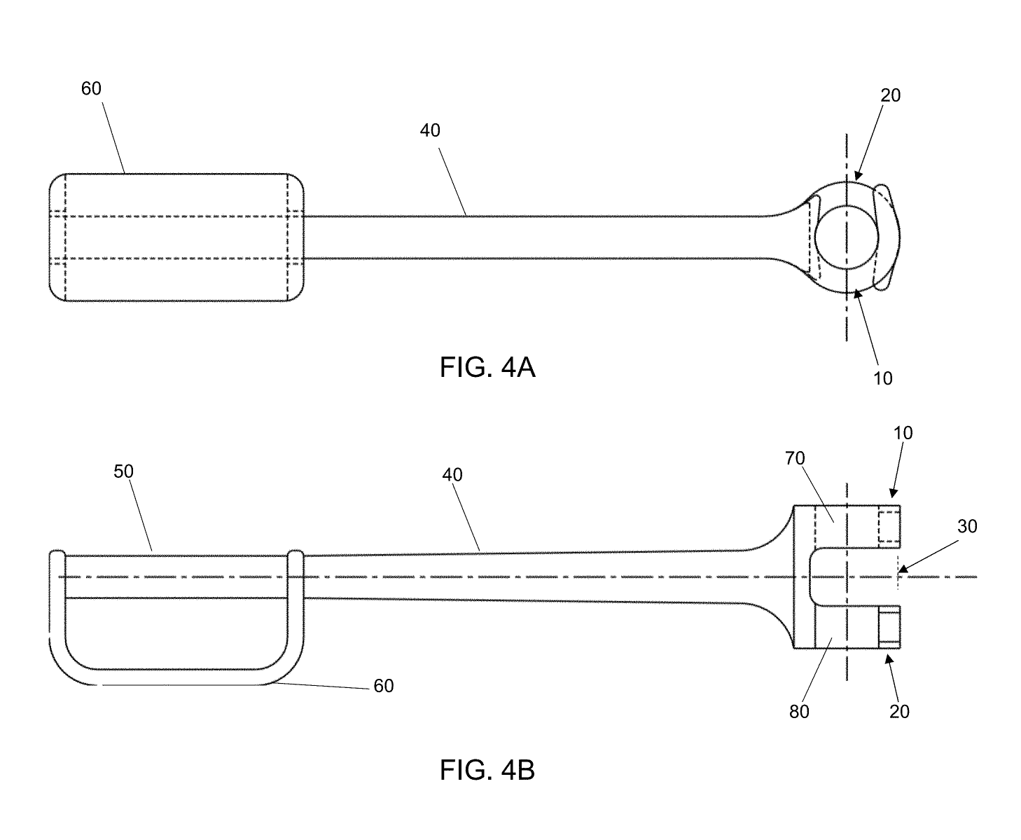

FIGS. 4A and 4B show top and side and sectional views of an example embodiment of a valve wrench in accordance with the present disclosure. FIG. 4A shows a partial cutaway view of guard member 60 surrounding a portion of shaft 40 at a second end, opposite to that of first end jaw assembly with first and second jaws 10, 20. FIG. 4B shows a side view of guard member 60 that surrounds a portion of shaft 40 forming handle 50. Jaw assembly at first end includes first jaw 10 and second jaws 20. First seat 70 and second seat 80 are also shown. It will be appreciated that according to some embodiments, first and second seats 70, 80 may be contoured to grip one or more portions of a valve wheel.

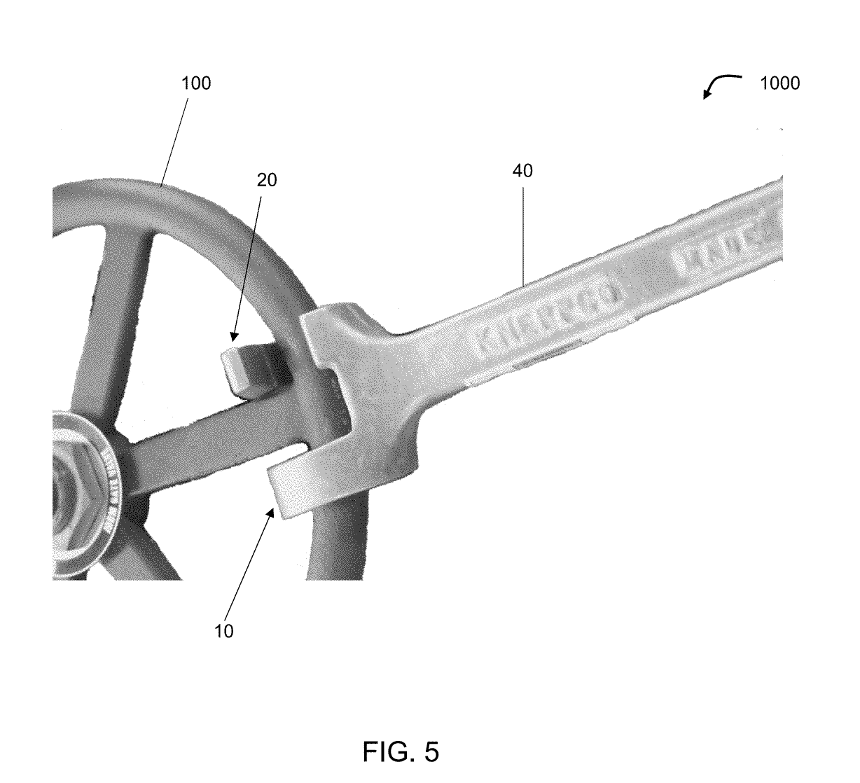

FIG. 5 is a partial perspective view of a valve wrench 1000 in use on a valve wheel 100 in accordance with an embodiment of the present disclosure. As shown, first jaw 10 is in contact with a first, outer portion of valve wheel 100 and second jaw 20 is in contact with a second, inner portion of valve wheel 100. Although shown associated with a valve wheel wrench configuration, jaw assemblies could also be utilized with different types of valves and valves having different shapes and sizes, for example, valves that have various rim diameters.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

The Abstract at the end of this disclosure is provided to comply with 37 C.F.R. § 1.72(b) to allow the reader to quickly ascertain the nature of the technical disclosure. It is submitted with the understanding that it will not be used to interpret or limit the scope or meaning of the claims.

Although the present invention has been described in detail, it should be understood that various changes, substitutions and alterations can be made thereto without departing from the spirit and scope of the invention as defined by the appended claims.

Therefore, at least the following is claimed:

1. A valve wheel wrench comprising:
a jaw assembly at a first end comprising first and second jaws configured to securably engage at least a portion of a valve wheel, wherein the orientation of the first jaw is opposite to the orientation of the second jaw; and
a handle at a second end, connected to the first end via a shaft, wherein a portion of the handle is surrounded by a guard configured to shield at least a portion of the hand of a user.

2. The valve wheel wrench of claim 1 wherein the jaw assembly further comprises a gap formed between the first and second jaws.

3. The valve wheel wrench of claim 1 wherein the first and second jaws have a gripping surface configured to engage with at least a portion of the contours of the valve wheel.

4. The valve wheel wrench of claim 1 wherein the guard is comprised of one or more loop members.

5. The valve wheel wrench of claim 1 wherein the guard comprises a basket shaped member.

6. The valve wheel wrench of claim 1 wherein the first and second jaws have a gripping surface configured to grip a first position and a second position of the valve wheel, respectively.

7. The valve wheel wrench of claim 1 wherein the first and second jaws have a gripping surface configured to grip an inner position and an outer position of a valve wheel, respectively.

8. A valve wheel wrench comprising:
a jaw assembly at a first end adapted to securably engage at least a portion of a valve wheel to turn it; and
a handle member at a second end, connected to the first end via a shaft, wherein a portion of the handle member, distal to the first end, comprises a guard member surrounding at least a portion of the shaft wherein the guard member is configured to protect one or more hands of a user.

9. The valve wheel wrench of claim 8 wherein the jaw assembly further comprises first and second jaws.

10. The valve wheel wrench of claim 8 wherein the guard member is comprised of one or more loop members.

11. The valve wheel wrench of claim 8 wherein the guard member comprises a basket shaped member.

12. The valve wheel wrench of claim 8 wherein the jaw assembly further comprises opposably fixed jaws wherein a gap is formed there between to securably engage at least a portion of a valve wheel to turn it.

13. The valve wheel wrench of claim 12 wherein the first and second jaws have a gripping surface configured to grip an inner position of a valve wheel and an outer position of a valve wheel, respectively.

14. A valve wheel wrench comprising:
a first end comprising first and second jaws opposably oriented and separated by an opening there between to accept and securably engage at least a portion of the valve wheel; and
a handle at second end, connected to the first end via a shaft, wherein the handle comprises a guard member surrounding at least a portion of the shaft and is configured to protect at least a portion of the hand of a user.

15. The valve wheel wrench of claim 14 wherein the guard member is comprised of one or more loop members.

16. The valve wheel wrench of claim 14 wherein the guard member comprises a basket shaped member.

17. The valve wheel wrench of claim 14 wherein the guard member comprises a cup shaped member.

18. The valve wheel wrench of claim 14 wherein the first and second jaws have a gripping surface configured to engage with at least a portion of the contours of the valve wheel.

19. The valve wheel wrench of claim 14 wherein the first and second jaws have a gripping surface configured to engage with at least a portion of the contours of the valve wheel at a first and second position, respectively.

20. The valve wheel wrench of claim 14 wherein the first and second jaws further comprise a first jaw seat configured to grip a first position of a valve wheel and second jaw seat configured to grip a second position of a valve wheel, respectively.
